(19) United States
(12) Patent Application Publication
(10) Pub. No.: US 2012/0223870 A1
(43) Pub. Date: Sep. 6, 2012

(54) DIRECTIONAL ANTENNA FOR PORTABLE DEVICES

(75) Inventors: Lluis Boadas Siles, Mataro (Barcelona) (ES); Jordi Soler Castany, Mataro (Barcelona) (ES); Andreu Lopez Pou, Mataro (Barcelona) (ES)

(73) Assignee: Tinytronic, S.L., Mataro (Barcelona) (ES)

(21) Appl. No.: 13/390,982

(22) PCT Filed: Jul. 22, 2010
(86) PCT No.: PCT/ES2010/070505

§ 371 Date: May 22, 2012

(30) Foreign Application Priority Data
Aug. 18, 2009 (ES) P 200930606

(51) Int. Cl. H01Q 19/10; H01Q 9/16

(52) U.S. Cl. 343/818

(57) ABSTRACT

The present invention relates to a directional antenna comprising a dipole-configured active element, including two arms (2a, 2b), and a reflector element, including two parts (3a, 3b) inclined towards the arms (2a, 2b). The electrical length of the active element is equal to or less than 0.4 times and equal to or greater than 0.15 times the wavelength associated with the frequency of the radio link or communication. The angle between each inclined part (3a, 3b) of the reflector element and a line (4) parallel to the arms (2a, 2b) is equal to or greater than 15° and equal to or less than 45°.

### TECHNICAL FIELD OF THE INVENTION

The present invention relates to the sector of directional antennas, in general, and more particularly to directional antennas for portable devices.

### BACKGROUND OF THE INVENTION

The radio-tracking technique allows incorporating emitters on animals, objects or people to later locate them through a receiver which communicates with the emitter with electromagnetic signals, even over very long distances in the range of several tens of kilometers. This technique can be used in any application that needs to locate an object, and subsequently track and follow the object, or receive data or voice over a long distance while the object is moving. The tracking process is also known as “radio-tracking”. The radio-tracking technique is based on the emission of radio-electric pulses from a transmitter at a given frequency, using an omnidirectional antenna to radiate energy in all directions, and the reception of said pulses by a receiver, tuned to the frequency in question, through a directional antenna. The directional antenna in the receiver allows angularly discerning the power changes of the received signal and therefore provides an estimation of the direction from where the electromagnetic pulses originate.

The directional antennas of the portable radio-tracking equipment can be internal antennas, i.e., integrated in the same receiver or external antennas. Portable devices with internal antennas are for example the Marshall Radio Telemetry radio-tracking receivers and the devices disclosed in the manual “Tracker® Radio Location Tracking User's Guide”, version 1.1, 2008. The integrated antennas shown in this manual have a meander-shaped active element to reduce the size of the antenna. However, this technique is not very suitable because although it is useful to reduce the size of the antenna, it reduces the directivity and gain of the antenna. In the case of external antennas, the antenna is a separate accessory of the receiver and is connected to the receiver by means of a cable with a connector. Examples of external antennas are Yagi antennas with flexible elements from Lintec Antennas and Followit directional antennas.

At low frequencies the receiver antennas are generally external antennas because the size of the antenna is too large to be able to be integrated in the receiver and to assure the performances of the receiver in terms of portability and antenna radiation properties, which are virtually, directivity, front to back ratio and gain. There is therefore a need to provide new solutions for directional antennas operating at low frequencies small enough to continue assuring the performances of the receiving equipment both in terms of portability and antenna radiation diagram.

Another problem to be solved for low frequency antennas for portable devices is the effect of the hand holding the receiver over the performances of the antenna, which commonly results, in the case of internal antennas, in the detuning of the antenna. There is therefore a need to design an antenna which is immune to the effect of hand-held portability.

### DESCRIPTION OF THE INVENTION

An objective of the invention is to solve the problems described above, among others. To that end, according to the invention a directional antenna according to independent claim 1 is provided. The dependent claims described particular embodiments of the invention.

According to one aspect of the invention, a directional antenna formed by an active element, which is powered, and another non-powered reflector element is provided. The configuration of the active element and of the reflector element is that of a Yagi antenna. The active element is a dipole-configured antenna formed by two arms. The reflector element includes two parts inclined towards the arms. The inclined parts of the reflector element preferably have a dimension greater than the arms of the active element. The total length of the active element, including the two arms of the dipole, is equal to or less than 0.4 times and equal to or greater than 0.15 times the wavelength associated with the working frequency of the antenna. The working frequency of the antenna is not understood as its resonance frequency, but the radio link or communication frequency of the device with the antenna. The angle between each inclined part of the reflector element and a line parallel to the arms is equal to or greater than 15° and equal to or less than 45°.

The antenna according to the invention is smaller than the directional antennas known for radio-tracking and therefore results in an improved portability of the portable device with the antenna. Antenna radiation properties are assured at the same time. Furthermore, the design of the antenna itself assures that it is less sensitive to the effect of the hand than with other antenna designs where the effect of the hand significantly worsens the performances of the antenna. The hand holding the device with the antenna does not affect the performances of the antenna much.

The directional antenna according to the invention is preferably used with low working frequencies, for example, in the 145 MHz to 154 MHz band or 151 MHz to 156 MHz band or 173 MHz to 174 MHz band or 216 MHz to 220 MHz band or 233 MHz to 350 MHz band.

The arms of the active element are preferably rectilinear, i.e., not curve. In a preferred embodiment the arms are standard telescopic antennas. This allows the user to slide the arms inwards when the device is not functioning, thus further improving the portability of the receiving device.

Since the dipole active element is a balanced element, the power of said active element is preferably also balanced, for example, by a twin cable or a coaxial cable plus balun. However the power of the dipole can also be unbalance, for example, through a coaxial cable.

The power of the active element can be symmetrical or non symmetrical. This refers to the relative position of the power in the active element in relation to its midpoint. What is common and preferred is that the power is in the centre of the dipole, but in other embodiments it can be at points other than the centre.

According to one embodiment the reflector element is connected to the ground plane of a printed circuit of the electronics of the portable device with the antenna. This connection can be made at the midpoint of the reflector element or at a point shifted with respect to the centre thereof.

The casing of the portable device can be a plastic or metal casing. If the casing is a metal casing, the reflector element can be connected to said casing. The metal casing is in turn connected to the ground plane of the printed circuit of the electronics of the portable device.

The directional antenna is preferably used in a radio-tracking receiving device, although it can also be used for other applications where a small directional antenna for portable equipment is required.

### DESCRIPTION OF THE DRAWINGS

The invention will be better understood and its numerous objectives and advantages will be more obvious for the persons skilled in the art with reference to the following drawings, together with the accompanying specification, in which:

FIG. 1 shows an example of a directional antenna according to the principles of the present invention.

FIG. 2 shows a radiation diagram of the directional antenna shown in FIG. 1.

### PREFERRED EMBODIMENTS OF THE INVENTION

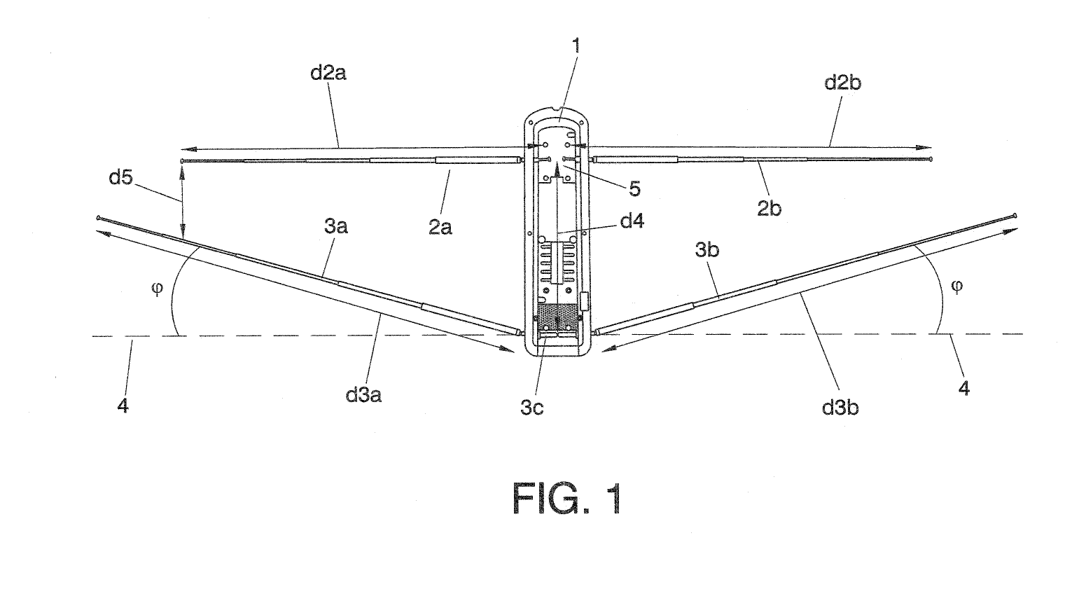

A practical embodiment of the invention can be described herein in view of the mentioned drawings. As observed in FIG. 1 the directional antenna is part of a portable device, for example, a radio-tracking device, comprising a casing 1 (only the rear part thereof is shown in the drawing) and a printed circuit board of the electronics of the receiver among other things. The antenna comprises an active element and a reflector element. The active element is a dipole-configured antenna formed by two arms 2a, 2b made of a conductive material. The reflector element includes two parts 3a, 3b inclined towards the arms 2a, 2b and a part 3c between the two inclined parts 3a, 3b, all the parts are made of a conductive material. The arms 2a, 2b and the inclined parts 3a, 3b are rectilinear and are formed by telescopic antennas of the type which are commonly used in portable radio equipment.

The working frequency band of the device with the exemplary antenna shown in FIG. 1 is from 151 to 156 MHz. The electrical length of the active element of the antenna, which is the sum of the length d2a (397 mm) of the arm 2a and the length d2b (397 mm) of the arm 2b is 794 mm, i.e., approximately 0.397 lambda, in which lambda is the wavelength associated with the operating frequency of the portable device. The electrical length of the reflector element, which is the sum of the length d3a (454 mm) of the part 3a and the length d3b (454 mm) of the part 3b is 0.454 lambda. The distance d4 between the part 3c of the reflector element and the midpoint 5 of the active element is 198 mm. The gap d5 between the arms 2a, 2b and the parts 3a, 3b taken at the end of the arms is 95 mm. This gap depends on the desired configuration of variables of the active element and of the reflector element.

According to the invention the electrical length of the active element is equal to or less than 0.4 times lambda and equal to or greater than 0.15 times lambda and the angle φ between each inclined part 3a, 3b of the reflector element and a line 4 parallel to the arms 2a, 2b is equal to or greater than 15° and equal to or less than 45°.

The working frequency of the active element (dipole) of the antenna according to the invention is not the first resonance frequency of the dipole. In other words, the antenna is working in a non-resonant mode. The working frequency of the active element is understood as the frequency used by the device to establish the radio link or communication. Furthermore, an impedance matching network must be inserted between the radio frequency terminal and the antenna power point to maximize the power transfer between the antenna and the radio frequency terminal (receiver or transmitter).

In the embodiment of the antenna according to FIG. 1, the power of the active element is symmetrical, i.e., at the midpoint 5 (centre) of the dipole. However, in other embodiments the active element can supplied in points other than the centre. The power can be a balanced power, for example through a twin cable or a coaxial cable plus balun or an unbalance power, for example through a coaxial cable.

Together with the active element and reflector, the portable device tends to comprise, among other components, a printed circuit board associated with the electronics of the device. The casing 1 of the device can be a plastic or metal casing. If the casing is a metal casing the reflector element can be connected to ground through the casing since the metal casing is then commonly connected to the ground plane of the printed circuit of the electronics of the device. If the casing is a plastic casing, what is most efficient is to connect the reflector element directly to the ground plane of the electronic printed circuit of the receiver. The reflector can be connected to ground at the midpoint of the reflector element or at a point shifted with respect to the centre thereof.

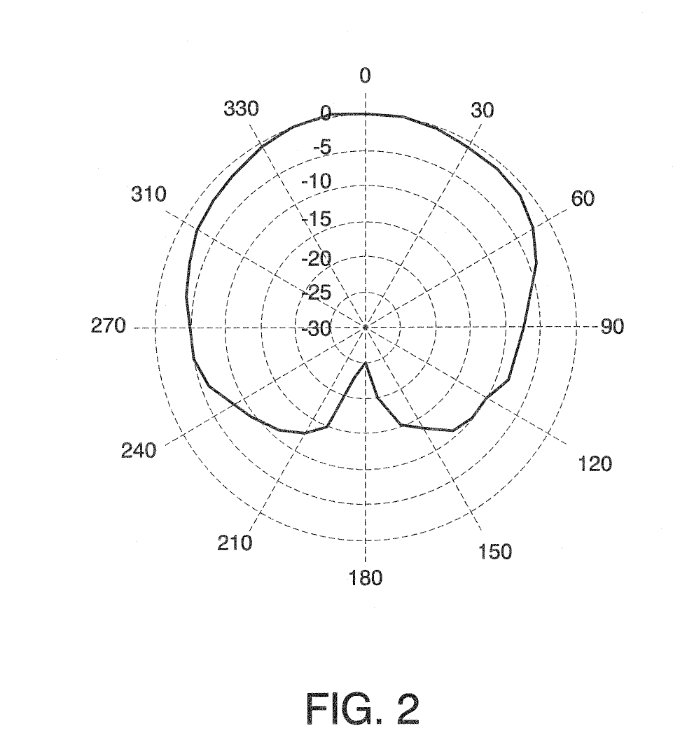

FIG. 2 shows a radiation diagram of the directional antenna according to FIG. 1. The maximum gain is 2 dB. The front to back ratio is 24.7 dB.

Although the invention has been illustrated and described in detail in the drawings and the description above, such illustration and description must be considered as illustrative or by way of examples and non-restrictive; the invention is not limited to the embodiments disclosed.

The invention can of course be implemented for working frequencies other than the 151 to 156 MHz band, for example in the 145 MHz to 154 MHz band or 173 MHz to 174 MHz band or 216 MHz to 220 MHz band or 233 MHz to 350 MHz band. Although the directional antenna is particularly favorable for portable radio-tracking devices, for example to track the movements of animals or to track people or cars in security applications, it can also be used for other applications where a small directional antenna for portable equipment is required or even for applications requiring a fixed directional antenna.

The persons skilled in the art can understand and carry out other variations of the embodiments disclosed by putting the claimed invention into practice, from analyzing the drawings, the specification, and the attached claims. In the claims, the term “which comprises” or “comprising” does not exclude other elements or steps, and the indefinite article “a” or “an” does not exclude plurality. The mere fact that certain measures are mentioned in different mutually dependent claims does not indicate that a combination of these measures cannot be advantageously used. Reference symbols in the claims must not be interpreted as limiting the scope.

1. Directional antenna comprising a dipole-configured active element, including two arms (2a, 2b), and a reflector element, including two parts (3a, 3b) inclined towards the arms,
characterized in that
the electrical length of the active element is equal to or less than 0.4 times and equal to or greater than 0.15 times the wavelength associated with the working frequency of the radio link or communication and
the angle (φ) between each inclined part (3a, 3b) of the reflector element and a line (4) parallel to the arms (2a, 2b) is equal to or greater than 15° and equal to or less than 45°.

2. Antenna according to claim 1, characterized in that the arms (2a, 2b) are rectilinear.

3. Antenna according to claim 1 or 2, characterized in that the arms (2a, 2b) and the inclined parts (3a, 3b) are formed by telescopic antennas.

4. Antenna according to any of the preceding claims, characterized in that the inclined parts (3a, 3b) of the reflector element have a dimension greater than the arms (2a, 2b) of the active element.

5. Antenna according to any of the preceding claims, characterized in that its working frequency is in the 145 MHz to 154 MHz band or 151 MHz to 156 MHz band or 173 MHz to 174 MHz band or 216 MHz to 220 MHz band or 233 MHz to 350 MHz band.

6. Antenna according to any of the preceding claims, characterized in that the power of the active element is a balanced power.

7. Antenna according to any of claims 1-5, characterized in that the power of the active element is an unbalance power.

8. Antenna according to any of the preceding claims, characterized in that the power of the active element is symmetrical, i.e., in the centre (5) of the active element.

9. Antenna according to any of claims 1-7, characterized in that the power of the active element is not symmetrical, i.e., not in the centre of the active element.

10. Portable device comprising an antenna according to any of the preceding claims.

11. Device according to claim 10, characterized in that the reflector element is connected to the ground plane of a printed circuit of the electronics of the device.

12. Device according to claim 11, characterized in that the reflector element is connected to the ground plane of the printed circuit of the electronics at the midpoint of the reflector.

13. Device according to claim 11, characterized in that the reflector element is connected to the ground plane of the printed circuit of the electronics at a point shifted with respect to the midpoint of the reflector.

14. Device according to claim 10, characterized in that it comprises a metal casing and the reflector element is connected to said casing.

15. Device according to claim 14, characterized in that the metal casing is connected to the ground plane of a printed circuit of the electronics of the device.

16. Device according to any of claims 10-15, characterized in that it is a radio-tracking receiving device.
